(19) United States
(12) Patent Application Publication
(10) Pub. No.: US 2019/0345876 A1
(43) Pub. Date: Nov. 14, 2019

(54) METHOD OF POSITIONING TWO PARTS RELATIVE TO EACH OTHER IN A FORMLOCKING CONNECTION, A FORMLOCKING DEVICE AND GAS TURBINE ENGINE

(71) Applicant: Rolls-Royce Deutschland Ltd & Co KG, Blankenfelde-Mahlow (DE)

(72) Inventor: Andreas GOUMAS, Berlin (DE)

(21) Appl. No.: 16/391,860

(22) Filed: Apr. 23, 2019

(30) Foreign Application Priority Data
May 11, 2018 (DE) 10 2018 207 370.8

(51) Int. Cl. F02C 7/36; F02K 3/06; F16H 1/28

(52) U.S. Cl. CPC F02C 7/36; F02K 3/06; F16H 1/28; F05D 2260/40311; F05D 2240/20; F05D 2230/60; F05D 2260/83; F05D 2220/323

(57) ABSTRACT

A method for positioning two parts relative to each other in a formlocking connection, the two parts having a plurality of contact faces o transmit contact forces between the two parts, computing for each possible relative position of the two parts the contact forces between the two parts and determining the relative position of the two parts with the minimal contact force among a plurality of relative positions or all possible relative positions and assembling the two parts relative to each other in the position with the minimal contact force. A formlocking device and a gas turbine engine.

This application claims priority to German Patent Application DE102018207370.8 filed May 11, 2018, the entirety of which is incorporated by reference herein.

The present disclosure relates to a method of positioning a spline connection with the features of claim 1.

In many mechanical devices, such as gearboxes, parts forming a formlocking connection when assembled, transmit torque via contact faces of the two parts. One typical formlocking connection is a spline connection. The two parts forming the connection need to be assembled correctly.

Current part verification procedure implies that, for every part, e.g. spline teeth are measured to confirm they have been manufactured according to drawing definition. Therefore, an arbitrary clocking position of the actual assembly of the two toothed parts in the formlocking connection is used. The part measurement data is not used to derive specific part assembly instructions.

Therefore, improved methods for positioning of parts with fixed geometries in a formlocking connection, e.g. in a spline connection, are required.

This is addressed by a method with the features of claim 1.

The method results in a better positioning of two parts with existing, fixed geometries relative to each other in a formlocking connection. The two parts having a plurality of contact faces to transmit contact forces between the two parts. If the two parts are e.g. meshing splines, the flanks of the splines are the contact faces forming the formlocking connection. The contact forces are transmitted across those contact faces.

In a first step, for each possible relative position of the two parts, the contact forces between the two parts are computed. The geometry of the two parts, in particular the contact faces, are known or can be calculated or measured. The external forces on the formlocking connection and the material properties are known. With this data, e.g. a Finite Element Method can be used to calculate the contact forces, in particular the absolute value.

In a second step, the relative position (e.g. clocking position of a spline connection) of the two parts with the minimal contact force is determined. This requires the calculation of the contact force (first step) for a plurality or all possible relative positions of the two parts.

In a third step, the two parts are assembled relative to each other in this position with the minimal contact force.

In the exemplary context of a spline connection in a planetary gearbox, the spline teeth measurement data for every part is determined to find a distinct clocking configuration to assemble every pair of e.g. a sun shaft and e.g. sun gear such that contact force is minimized and hence the HCF strength of the parts are maximized.

In one embodiment of the method, the minimal contact force is defined as the minimal absolute value of the contact forces at the determined relative positions or the average minimal value of the contact forces at the determined relative positions. Both approaches allow an assessment of the quality of the fit of the formlocking connection. It is also possible to minimize the alternating contact force

The alternating force of each spline tooth is calculated by subtracting the minimum from the maximum contact force of the spline tooth as the formlocking connection completes a revolution and divide by 2.

In one further embodiment at least one geometric property is measured in the area of the contact forces, in positional tolerance between the two parts.

The formlocking connection subjected to an embodiment of the method can comprise a cylindrical spline connection, in particular with a polygonal connection, square splines, serrated splines, straight side splines, involute shaped splines or tapered tooth splines. Cylindrical spline connections are e.g. used in connecting a sun shaft with a sun gear. A square spline e.g. is a geometrical simple spline connection, in which a first part with four flat surfaces is inserted into a second part with a matching opening. The square spline is a special case of a polygonal spline.

It is also possible to apply an embodiment of the method to formlocking connections comprising a face spline connection, in particular are radial serration spline or a curvic coupling.

Both kinds of spline connections care frequently used in machinery, in particular in aircraft engines.

In one possible application of an embodiment of the method, the first part is a sun gear and the second part is a sun gear of a planetary gearbox, in particular in a geared turbofan engine in an aircraft. Gearboxes in geared turbofan engines have to transmit large torques and have to operate over very long periods of time. Therefore, the minimization of contact forces is particularly important.

But spline connections (cylindrical or face connection) can be used in other contexts as well. For example, the spline connections can be used to connect shafts in an aircraft engine. Naturally, the method is also applicable to other types of machinery in which spline connections are used.

The issue is also addressed by a formlocking device with the features of claim 9.

The formlocking device comprises two parts having a plurality of contact faces to transmit contact forces between the two parts, the two parts positionable by an embodiment of the method as described.

Furthermore, the issue is also addressed by a gas turbine engine with the features of claim 10.

The engine comprises an engine core comprising a turbine, a compressor, and a core shaft connecting the turbine to the compressor; a fan located upstream of the engine core, the fan comprising a plurality of fan blades; and a gearbox that receives an input from the core shaft and outputs drive to the fan so as to drive the fan at a lower rotational speed than the core shaft, wherein the gearbox comprises a sun gear and a sun shaft assembled by an embodiment of the method described.

As noted elsewhere herein, the present disclosure may relate to a gas turbine engine. Such a gas turbine engine may comprise an engine core comprising a turbine, a combustor, a compressor, and a core shaft connecting the turbine to the compressor. Such a gas turbine engine may comprise a fan (having fan blades) located upstream of the engine core.

Arrangements of the present disclosure may be particularly, although not exclusively, beneficial for fans that are driven via a gearbox. Accordingly, the gas turbine engine may comprise a gearbox that receives an input from the core shaft and outputs drive to the fan so as to drive the fan at a lower rotational speed than the core shaft. The input to the gearbox may be directly from the core shaft, or indirectly from the core shaft, for example via a spur shaft and/or gear. The core shaft may rigidly connect the turbine and the compressor, such that the turbine and compressor rotate at the same speed (with the fan rotating at a lower speed).

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) flow from the first compressor.

The gearbox may be arranged to be driven by the core shaft that is configured to rotate (for example in use) at the lowest rotational speed (for example the first core shaft in the example above). For example, the gearbox may be arranged to be driven only by the core shaft that is configured to rotate (for example in use) at the lowest rotational speed (for example only be the first core shaft, and not the second core shaft, in the example above). Alternatively, the gearbox may be arranged to be driven by any one or more shafts, for example the first and/or second shafts in the example above.

In any gas turbine engine as described and/or claimed herein, a combustor may be provided axially downstream of the fan and compressor(s). For example, the combustor may be directly downstream of (for example at the exit of) the second compressor, where a second compressor is provided. By way of further example, the flow at the exit to the combustor may be provided to the inlet of the second turbine, where a second turbine is provided. The combustor may be provided upstream of the turbine(s).

The or each compressor (for example the first compressor and second compressor as described above) may comprise any number of stages, for example multiple stages. Each stage may comprise a row of rotor blades and a row of stator vanes, which may be variable stator vanes (in that their angle of incidence may be variable). The row of rotor blades and the row of stator vanes may be axially offset from each other.

The or each turbine (for example the first turbine and second turbine as described above) may comprise any number of stages, for example multiple stages. Each stage may comprise a row of rotor blades and a row of stator vanes. The row of rotor blades and the row of stator vanes may be axially offset from each other.

Each fan blade may be defined as having a radial span extending from a root (or hub) at a radially inner gas-washed location, or 0% span position, to a tip at a 100% span position. The ratio of the radius of the fan blade at the hub to the radius of the fan blade at the tip may be less than (or on the order of) any of: 0.4, 0.39, 0.38 0.37, 0.36, 0.35, 0.34, 0.33, 0.32, 0.31, 0.3, 0.29, 0.28, 0.27, 0.26, or 0.25. The ratio of the radius of the fan blade at the hub to the radius of the fan blade at the tip may be in an inclusive range bounded by any two of the values in the previous sentence (i.e. the values may form upper or lower bounds). These ratios may commonly be referred to as the hub-to-tip ratio. The radius at the hub and the radius at the tip may both be measured at the leading edge (or axially forwardmost) part of the blade. The hub-to-tip ratio refers, of course, to the gas-washed portion of the fan blade, i.e. the portion radially outside any platform.

The radius of the fan may be measured between the engine centreline and the tip of a fan blade at its leading edge. The fan diameter (which may simply be twice the radius of the fan) may be greater than (or on the order of) any of: 250 cm (around 100 inches), 260 cm, 270 cm (around 105 inches), 280 cm (around 110 inches), 290 cm (around 115 inches), 300 cm (around 120 inches), 310 cm, 320 cm (around 125 inches), 330 cm (around 130 inches), 340 cm (around 135 inches), 350cm, 360cm (around 140 inches), 370 cm (around 145 inches), 380 (around 150 inches) cm or 390 cm (around 155 inches). The fan diameter may be in an inclusive range bounded by any two of the values in the previous sentence (i.e. the values may form upper or lower bounds).

The rotational speed of the fan may vary in use. Generally, the rotational speed is lower for fans with a higher diameter. Purely by way of non-limitative example, the rotational speed of the fan at cruise conditions may be less than 2500 rpm, for example less than 2300 rpm. Purely by way of further non-limitative example, the rotational speed of the fan at cruise conditions for an engine having a fan diameter in the range of from 250 cm to 300 cm (for example 250 cm to 280 cm) may be in the range of from 1700 rpm to 2500 rpm, for example in the range of from 1800 rpm to 2300 rpm, for example in the range of from 1900 rpm to 2100 rpm. Purely by way of further non-limitative example, the rotational speed of the fan at cruise conditions for an engine having a fan diameter in the range of from 320 cm to 380 cm may be in the range of from 1200 rpm to 2000 rpm, for example in the range of from 1300 rpm to 1800 rpm, for example in the range of from 1400 rpm to 1600 rpm.

In use of the gas turbine engine, the fan (with associated fan blades) rotates about a rotational axis. This rotation results in the tip of the fan blade moving with a velocity Utip. The work done by the fan blades 13 on the flow results in an enthalpy rise dH of the flow. A fan tip loading may be defined as dH/Utip2, where dH is the enthalpy rise (for example the 1-D average enthalpy rise) across the fan and Utip is the (translational) velocity of the fan tip, for example at the leading edge of the tip (which may be defined as fan tip radius at leading edge multiplied by angular speed). The fan tip loading at cruise conditions may be greater than (or on the order of) any of: 0.3, 0.31, 0.32, 0.33, 0.34, 0.35, 0.36, 0.37, 0.38, 0.39 or 0.4 (all units in this paragraph being Jkg−1K−1/(ms−1)2). The fan tip loading may be in an inclusive range bounded by any two of the values in the previous sentence (i.e. the values may form upper or lower bounds).

Gas turbine engines in accordance with the present disclosure may have any desired bypass ratio, where the bypass ratio is defined as the ratio of the mass flow rate of the flow through the bypass duct to the mass flow rate of the flow through the core at cruise conditions. In some arrangements the bypass ratio may be greater than (or on the order of) any of the following: 10, 10.5, 11, 11.5, 12, 12.5, 13, 13.5, 14, 14.5, 15, 15.5, 16, 16.5, or 17. The bypass ratio may be in an inclusive range bounded by any two of the values in the previous sentence (i.e. the values may form upper or lower bounds). The bypass duct may be substantially annular. The bypass duct may be radially outside the core engine. The radially outer surface of the bypass duct may be defined by a nacelle and/or a fan case.

The overall pressure ratio of a gas turbine engine as described and/or claimed herein may be defined as the ratio of the stagnation pressure upstream of the fan to the stagnation pressure at the exit of the highest pressure compressor (before entry into the combustor). By way of non-limitative example, the overall pressure ratio of a gas turbine engine as described and/or claimed herein at cruise may be greater than (or on the order of) any of the following: 35, 40, 45, 50, 55, 60, 65, 70, 75. The overall pressure ratio may be in an inclusive range bounded by any two of the values in the previous sentence (i.e. the values may form upper or lower bounds).

Specific thrust of an engine may be defined as the net thrust of the engine divided by the total mass flow through the engine. At cruise conditions, the specific thrust of an engine described and/or claimed herein may be less than (or on the order of) any of the following: 110 Nkg-1s, 105 Nkg-1s, 100 Nkg-1s, 95 Nkg-1s, 90 Nkg-1s, 85 Nkg-1s or 80 Nkg-1s. The specific thrust may be in an inclusive range bounded by any two of the values in the previous sentence (i.e. the values may form upper or lower bounds). Such engines may be particularly efficient in comparison with conventional gas turbine engines.

A gas turbine engine as described and/or claimed herein may have any desired maximum thrust. Purely by way of non-limitative example, a gas turbine as described and/or claimed herein may be capable of producing a maximum thrust of at least (or on the order of) any of the following: 160 kN, 170 kN, 180 kN, 190 kN, 200 kN, 250 kN, 300 kN, 350 kN, 400 kN, 450 kN, 500 kN, or 550 kN. The maximum thrust may be in an inclusive range bounded by any two of the values in the previous sentence (i.e. the values may form upper or lower bounds). The thrust referred to above may be the maximum net thrust at standard atmospheric conditions at sea level plus 15 deg C (ambient pressure 101.3kPa, temperature 30 deg C), with the engine static.

In use, the temperature of the flow at the entry to the high pressure turbine may be particularly high. This temperature, which may be referred to as TET, may be measured at the exit to the combustor, for example immediately upstream of the first turbine vane, which itself may be referred to as a nozzle guide vane. At cruise, the TET may be at least (or on the order of) any of the following: 1400K, 1450K, 1500K, 1550K, 1600K or 1650K. The TET at cruise may be in an inclusive range bounded by any two of the values in the previous sentence (i.e. the values may form upper or lower bounds). The maximum TET in use of the engine may be, for example, at least (or on the order of) any of the following: 1700K, 1750K, 1800K, 1850K, 1900K, 1950K or 2000K. The maximum TET may be in an inclusive range bounded by any two of the values in the previous sentence (i.e. the values may form upper or lower bounds). The maximum TET may occur, for example, at a high thrust condition, for example at a maximum take-off (MTO) condition.

A fan blade and/or aerofoil portion of a fan blade described and/or claimed herein may be manufactured from any suitable material or combination of materials. For example at least a part of the fan blade and/or aerofoil may be manufactured at least in part from a composite, for example a metal matrix composite and/or an organic matrix composite, such as carbon fibre. By way of further example at least a part of the fan blade and/or aerofoil may be manufactured at least in part from a metal, such as a titanium based metal or an aluminium based material (such as an aluminium-lithium alloy) or a steel based material. The fan blade may comprise at least two regions manufactured using different materials. For example, the fan blade may have a protective leading edge, which may be manufactured using a material that is better able to resist impact (for example from birds, ice or other material) than the rest of the blade. Such a leading edge may, for example, be manufactured using titanium or a titanium-based alloy. Thus, purely by way of example, the fan blade may have a carbon-fibre or aluminium based body (such as an aluminium lithium alloy) with a titanium leading edge.

A fan as described and/or claimed herein may comprise a central portion, from which the fan blades may extend, for example in a radial direction. The fan blades may be attached to the central portion in any desired manner. For example, each fan blade may comprise a fixture which may engage a corresponding slot in the hub (or disc). Purely by way of example, such a fixture may be in the form of a dovetail that may slot into and/or engage a corresponding slot in the hub/disc in order to fix the fan blade to the hub/disc. By way of further example, the fan blades maybe formed integrally with a central portion. Such an arrangement may be referred to as a blisk or a bling. Any suitable method may be used to manufacture such a blisk or bling. For example, at least a part of the fan blades may be machined from a block and/or at least part of the fan blades may be attached to the hub/disc by welding, such as linear friction welding.

The gas turbine engines described and/or claimed herein may or may not be provided with a variable area nozzle (VAN). Such a variable area nozzle may allow the exit area of the bypass duct to be varied in use. The general principles of the present disclosure may apply to engines with or without a VAN.

The fan of a gas turbine as described and/or claimed herein may have any desired number of fan blades, for example 16, 18, 20, or 22 fan blades.

As used herein, cruise conditions may mean cruise conditions of an aircraft to which the gas turbine engine is attached. Such cruise conditions may be conventionally defined as the conditions at mid-cruise, for example the conditions experienced by the aircraft and/or engine at the midpoint (in terms of time and/or distance) between top of climb and start of decent.

Purely by way of example, the forward speed at the cruise condition may be any point in the range of from Mach 0.7 to 0.9, for example 0.75 to 0.85, for example 0.76 to 0.84, for example 0.77 to 0.83, for example 0.78 to 0.82, for example 0.79 to 0.81, for example on the order of Mach 0.8, on the order of Mach 0.85 or in the range of from 0.8 to 0.85. Any single speed within these ranges may be the cruise condition. For some aircraft, the cruise conditions may be outside these ranges, for example below Mach 0.7 or above Mach 0.9.

Purely by way of example, the cruise conditions may correspond to standard atmospheric conditions at an altitude that is in the range of from 10000 m to 15000 m, for example in the range of from 10000 m to 12000 m, for example in the range of from 10400 m to 11600 m (around 38000 ft), for example in the range of from 10500 m to 11500 m, for example in the range of from 10600 m to 11400 m, for example in the range of from 10700 m (around 35000 ft) to 11300 m, for example in the range of from 10800 m to 11200 m, for example in the range of from 10900m to 11100 m, for example on the order of 11000 m. The cruise conditions may correspond to standard atmospheric conditions at any given altitude in these ranges.

Purely by way of example, the cruise conditions may correspond to: a forward Mach number of 0.8; a pressure of 23000 Pa; and a temperature of −55 deg C.

As used anywhere herein, “cruise” or “cruise conditions” may mean the aerodynamic design point. Such an aerodynamic design point (or ADP) may correspond to the conditions (comprising, for example, one or more of the Mach Number, environmental conditions and thrust requirement) for which the fan is designed to operate. This may mean, for example, the conditions at which the fan (or gas turbine engine) is designed to have optimum efficiency.

In use, a gas turbine engine described and/or claimed herein may operate at the cruise conditions defined elsewhere herein. Such cruise conditions may be determined by the cruise conditions (for example the mid-cruise conditions) of an aircraft to which at least one (for example 2 or 4) gas turbine engine may be mounted in order to provide propulsive thrust.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

Embodiments will now be described by way of example only, with reference to the Figures, in which:

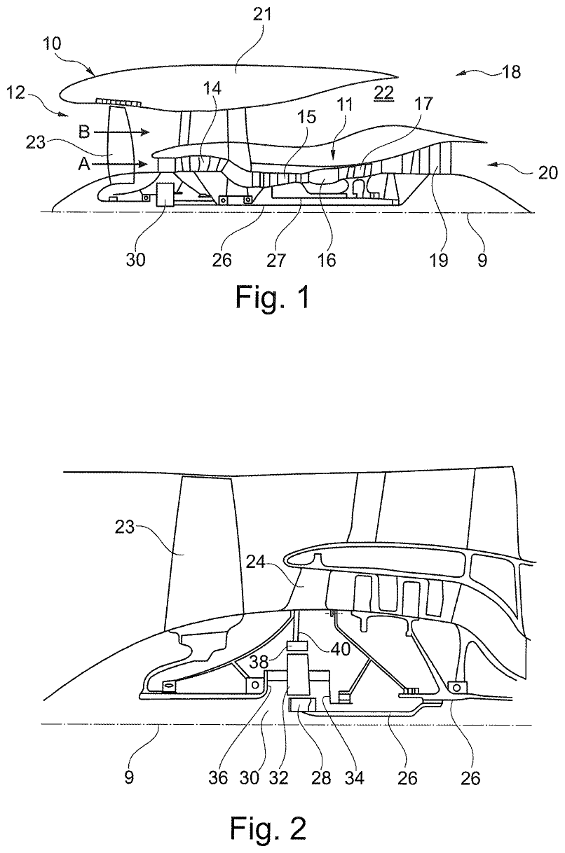

FIG. 1 is a sectional side view of a gas turbine engine;

FIG. 2 is a close up sectional side view of an upstream portion of a gas turbine engine;

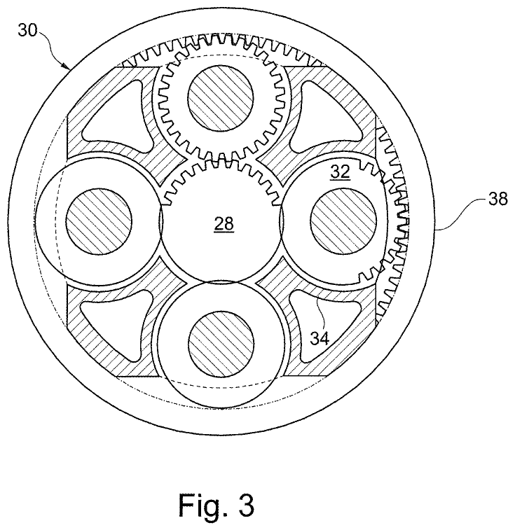

FIG. 3 is a partially cut-away view of a gearbox for a gas turbine engine;

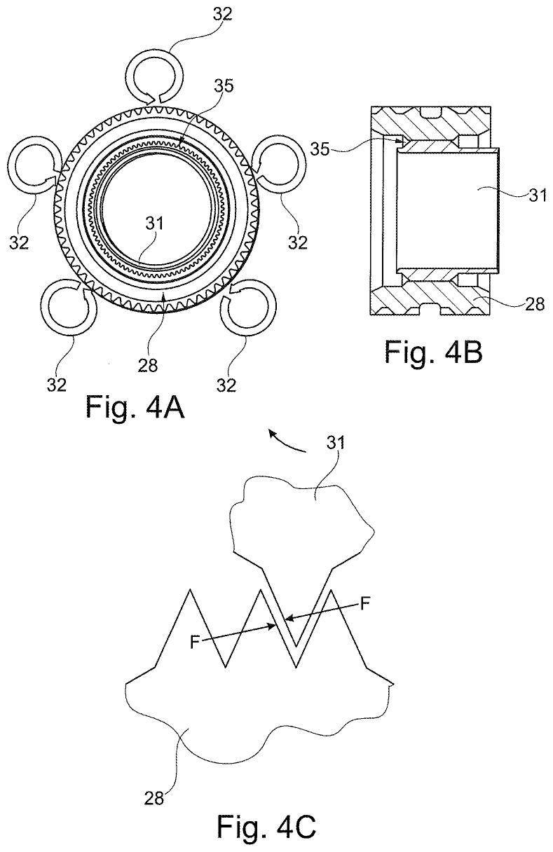

FIG. 4A is a frontal view of a sun shaft connected to a sun gear;

FIG. 4B is sectional sideview of the view of FIG. 4A;

FIG. 4C shows a form locking connection between the sun gear and the sun shaft shown in FIGS. 4A-4B;

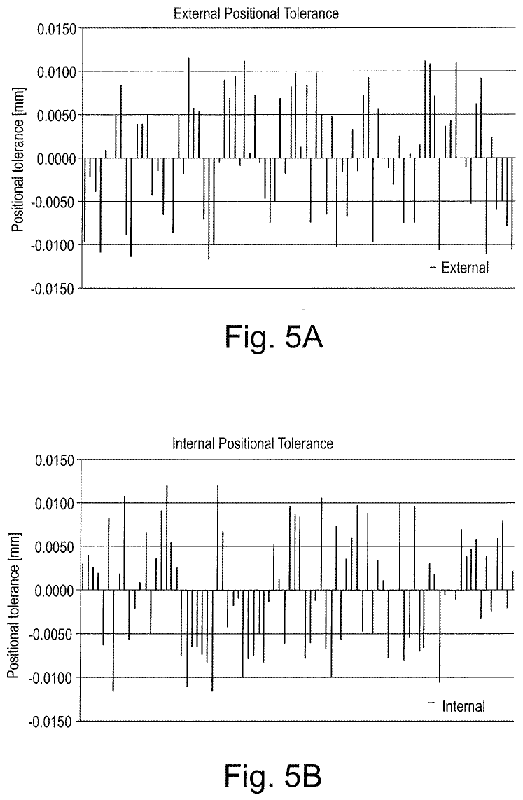

FIG. 5A is a graph showing the absolute positional tolerances of an external spline;

FIG. 5B is a graph showing the absolute positional tolerances of an internal spline;

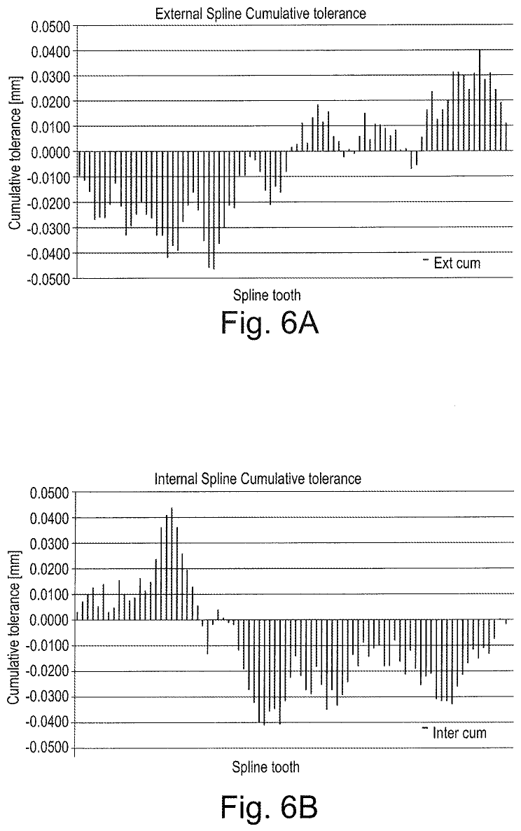

FIG. 6A is a graph showing the cumulative positional tolerances of the external spline in FIG. 5A;

FIG. 6B is a graph showing the cumulative positional tolerances of the internal spline in FIG. 5B;

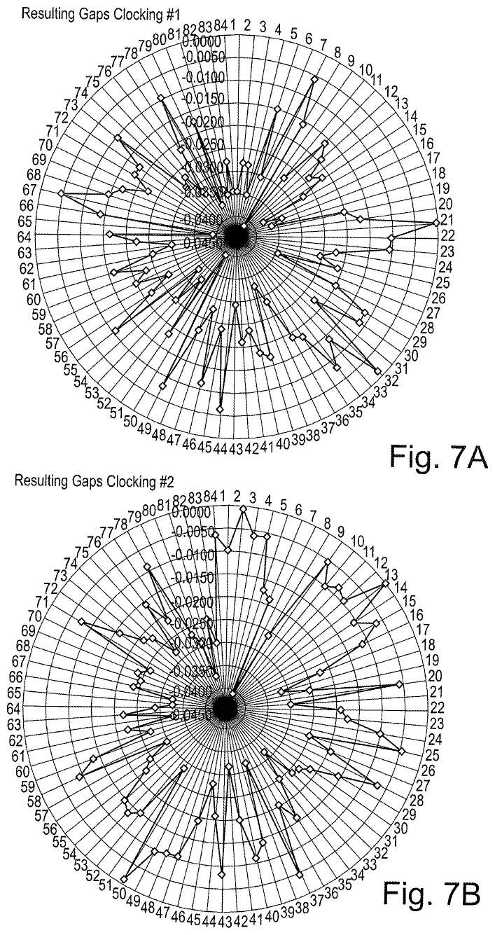

FIG. 7A is a graph indicating the minimized gaps between the teeth (clocking #1);

FIG. 7B is a graph indicating a further gap configuration (clocking #2);

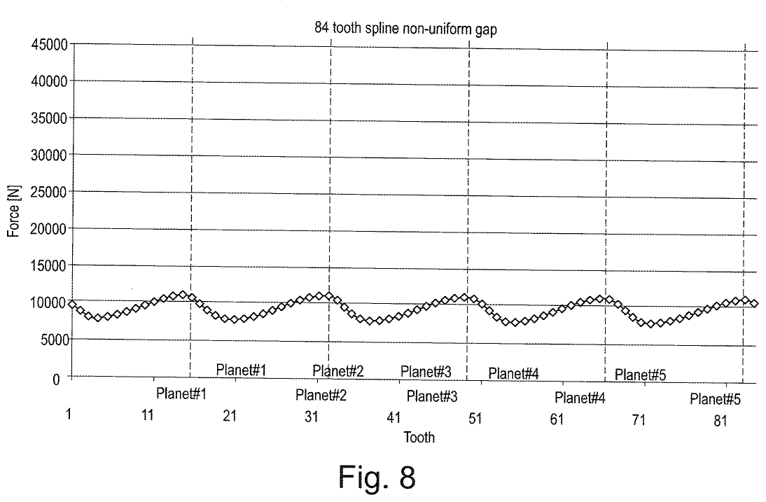

FIG. 8 is a graph indicating the spline contact force distribution with equal load share and in an idealized spline;

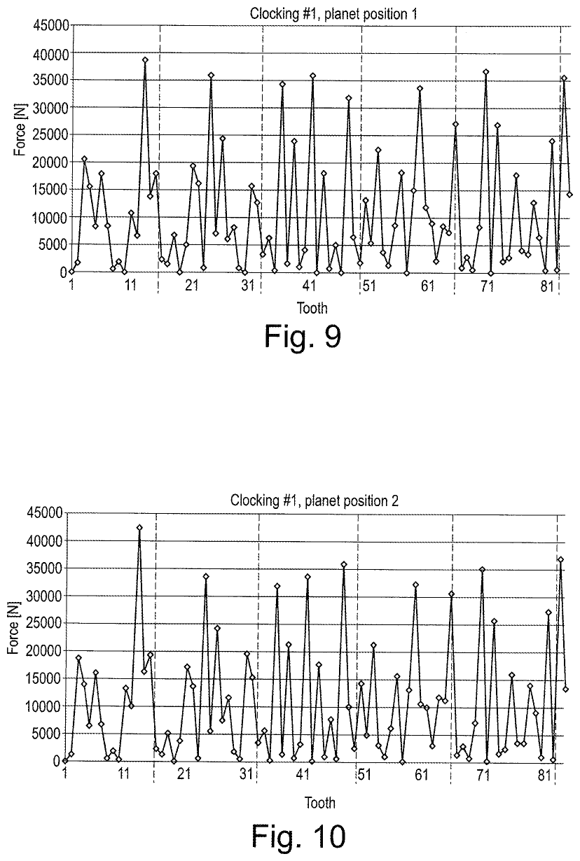

FIG. 9 is a graph showing the spline contact force distribution with a non-uniform gap, clocking position 1#, planet gear position 1;

FIG. 10 is a graph showing the spline contact force distribution with a non-uniform gap, clocking position 1#, planet gear position 2;

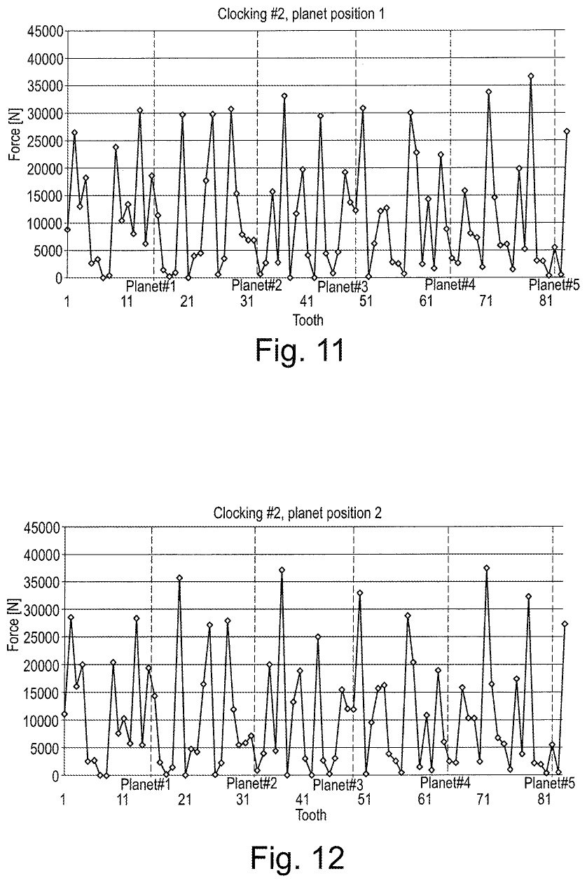

FIG. 11 is a graph showing the spline contact force distribution with a non-uniform gap, clocking position 2#, planet gear position 1;

FIG. 12 is a graph showing the spline contact force distribution with a non-uniform gap, clocking position 2#, planet gear position 2;

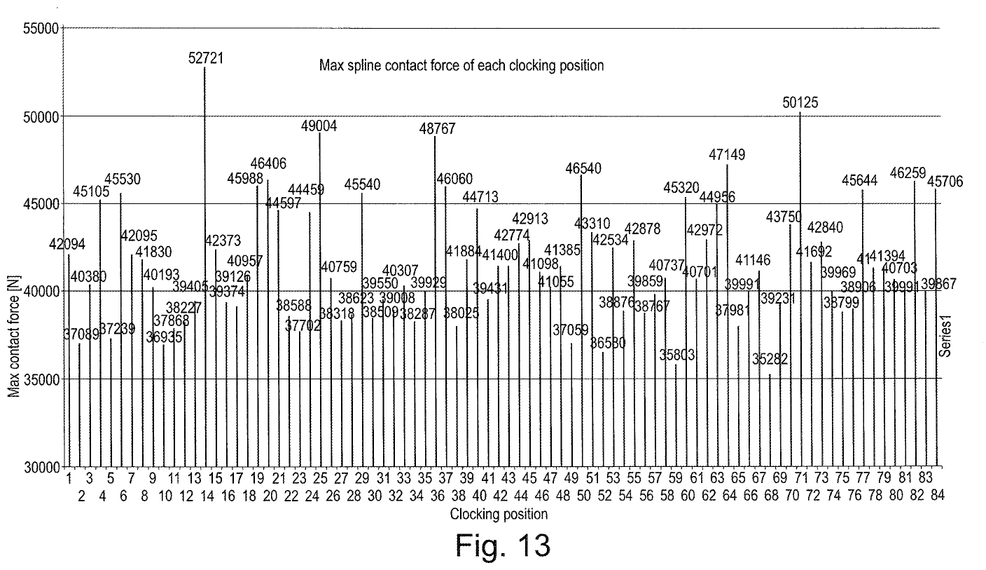

FIG. 13 is a graph showing the maximal spline contact force for each clocking position;

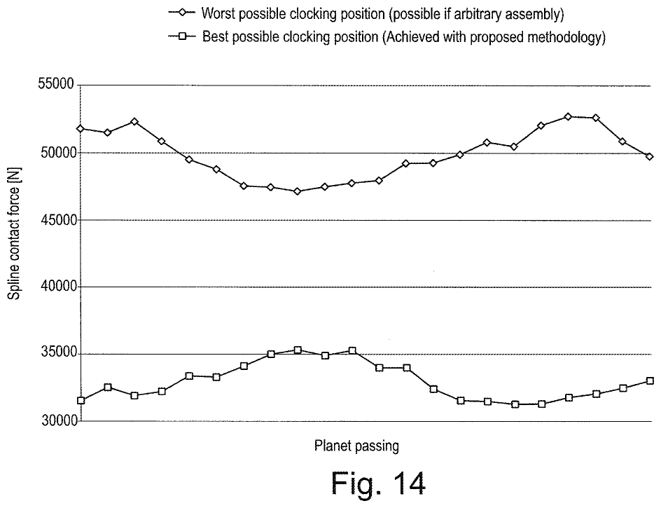

FIG. 14 is a graph showing the spline contact forces for a worst case and a best case.

FIG. 1 illustrates a gas turbine engine 10 having a principal rotational axis 9. The engine 10 comprises an air intake 12 and a propulsive fan 23 that generates two airflows: a core airflow A and a bypass airflow B. The gas turbine engine 10 comprises a core 11 that receives the core airflow A. The engine core 11 comprises, in axial flow series, a low pressure compressor 14, a high-pressure compressor 15, combustion equipment 16, a high-pressure turbine 17, a low pressure turbine 19 and a core exhaust nozzle 20. A nacelle 21 surrounds the gas turbine engine 10 and defines a bypass duct 22 and a bypass exhaust nozzle 18. The bypass airflow B flows through the bypass duct 22. The fan 23 is attached to and driven by the low pressure turbine 19 via a shaft 26 and an epicyclic gearbox 30.

In use, the core airflow A is accelerated and compressed by the low pressure compressor 14 and directed into the high pressure compressor 15 where further compression takes place. The compressed air exhausted from the high pressure compressor 15 is directed into the combustion equipment 16 where it is mixed with fuel and the mixture is combusted. The resultant hot combustion products then expand through, and thereby drive, the high pressure and low pressure turbines 17, 19 before being exhausted through the nozzle 20 to provide some propulsive thrust. The high pressure turbine 17 drives the high pressure compressor 15 by a suitable interconnecting shaft 27. The fan 23 generally provides the majority of the propulsive thrust. The epicyclic gearbox 30 is a reduction gearbox.

An exemplary arrangement for a geared fan gas turbine engine 10 is shown in FIG. 2. The low pressure turbine 19 (see FIG. 1) drives the shaft 26, which is coupled to a sun wheel, or sun gear, 28 of the epicyclic gear arrangement 30. Radially outwardly of the sun gear 28 and intermeshing therewith is a plurality of planet gears 32 that are coupled together by a planet carrier 34. The planet carrier 34 constrains the planet gears 32 to precess around the sun gear 28 in synchronicity whilst enabling each planet gear 32 to rotate about its own axis. The planet carrier 34 is coupled via linkages 36 to the fan 23 in order to drive its rotation about the engine axis 9. Radially outwardly of the planet gears 32 and intermeshing therewith is an annulus or ring gear 38 that is coupled, via linkages 40, to a stationary supporting structure 24.

Note that the terms “low pressure turbine” and “low pressure compressor” as used herein may be taken to mean the lowest pressure turbine stages and lowest pressure compressor stages (i.e. not including the fan 23) respectively and/or the turbine and compressor stages that are connected together by the interconnecting shaft 26 with the lowest rotational speed in the engine (i.e. not including the gearbox output shaft that drives the fan 23). In some literature, the “low pressure turbine” and “low pressure compressor” referred to herein may alternatively be known as the “intermediate pressure turbine” and “intermediate pressure compressor”. Where such alternative nomenclature is used, the fan 23 may be referred to as a first, or lowest pressure, compression stage.

The epicyclic gearbox 30 is shown by way of example in greater detail in FIG. 3. Each of the sun gear 28, planet gears 32 and ring gear 38 comprise teeth about their periphery to intermesh with the other gears. However, for clarity only exemplary portions of the teeth are illustrated in FIG. 3. There are four planet gears 32 illustrated, although it will be apparent to the skilled reader that more or fewer planet gears 32 may be provided within the scope of the claimed invention. Practical applications of a planetary epicyclic gearbox 30 generally comprise at least three planet gears 32.

The epicyclic gearbox 30 illustrated by way of example in FIGS. 2 and 3 is of the planetary type, in that the planet carrier 34 is coupled to an output shaft via linkages 36, with the ring gear 38 fixed. However, any other suitable type of epicyclic gearbox 30 may be used. By way of further example, the epicyclic gearbox 30 may be a star arrangement, in which the planet carrier 34 is held fixed, with the ring (or annulus) gear 38 allowed to rotate. In such an arrangement the fan 23 is driven by the ring gear 38. By way of further alternative example, the gearbox 30 may be a differential gearbox in which the ring gear 38 and the planet carrier 34 are both allowed to rotate.

It will be appreciated that the arrangement shown in FIGS. 2 and 3 is by way of example only, and various alternatives are within the scope of the present disclosure. Purely by way of example, any suitable arrangement may be used for locating the gearbox 30 in the engine 10 and/or for connecting the gearbox 30 to the engine 10. By way of further example, the connections (such as the linkages 36, 40 in the FIG. 2 example) between the gearbox 30 and other parts of the engine 10 (such as the input shaft 26, the output shaft and the fixed structure 24) may have any desired degree of stiffness or flexibility. By way of further example, any suitable arrangement of the bearings between rotating and stationary parts of the engine (for example between the input and output shafts from the gearbox and the fixed structures, such as the gearbox casing) may be used, and the disclosure is not limited to the exemplary arrangement of FIG. 2. For example, where the gearbox 30 has a star arrangement (described above), the skilled person would readily understand that the arrangement of output and support linkages and bearing locations would typically be different to that shown by way of example in FIG. 2.

Accordingly, the present disclosure extends to a gas turbine engine having any arrangement of gearbox styles (for example star or planetary), support structures, input and output shaft arrangement, and bearing locations.

Optionally, the gearbox may drive additional and/or alternative components (e.g. the intermediate pressure compressor and/or a booster compressor).

Other gas turbine engines to which the present disclosure may be applied may have alternative configurations. For example, such engines may have an alternative number of compressors and/or turbines and/or an alternative number of interconnecting shafts. By way of further example, the gas turbine engine shown in FIG. 1 has a split flow nozzle 20, 22 meaning that the flow through the bypass duct 22 has its own nozzle that is separate to and radially outside the core engine nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed flow nozzle. One or both nozzles (whether mixed or split flow) may have a fixed or variable area. Whilst the described example relates to a turbofan engine, the disclosure may apply, for example, to any type of gas turbine engine, such as an open rotor (in which the fan stage is not surrounded by a nacelle) or turboprop engine, for example. In some arrangements, the gas turbine engine 10 may not comprise a gearbox 30.

The geometry of the gas turbine engine 10, and components thereof, is defined by a conventional axis system, comprising an axial direction (which is aligned with the rotational axis 9), a radial direction (in the bottom-to-top direction in FIG. 1), and a circumferential direction (perpendicular to the page in the FIG. 1 view). The axial, radial and circumferential directions are mutually perpendicular.

In the following, an embodiment of a method for positioning (or assembling) two parts in a formlocking connection is described in the context of an epicyclic gearbox 30 in a geared turbofan engine.

The person skilled in the art will realize that other embodiments can be used in the context of other gearboxes, e.g. in stationary turbo engines. Other embodiments of the method can e.g. be used for spline connections outside a gearbox 30 context. This can e.g. be in context of a shaft connection with cylindrical splines (square splines, serrated splines, straight side splines, involute shaped splines or tapered tooth splines). Alternatively, an embodiment can be used for face splines, such as a radial serration spline or a curvic coupling.

With an epicyclic gearbox 30 in the context of a geared turbofan engine, a spline connection 35 is used to connect the sun shaft 31 and sun gear 28. Here, the sun gear 28 can be considered as the first part, the sun shaft 31 as the second part in the formlocking spline connection.

The teeth of the planet gears 32 mesh with the outer teeth of the sun gear 28. There exists a mechanical interaction between the planet teeth meshing with the sun gear 28 and the sun gear 29 to sun shaft spline 35 with contact forces F. This interaction is especially pronounced in the gearboxes 30 in geared turbofan engines due to its relative thin cross-section. The thin cross-section is necessary to accommodate the fan shaft, as well as to minimize weight.

In use, this interaction inflicts an alternating contact force on each spline tooth as a planet gear 32 passes. The number of alternating cycles equals the number of planet gears 32. In the gearbox 30 design shown in FIGS. 3, 4A and 4B, five planet gears 32 are used, thus each spline tooth would go through five alternating cycles per one revolution of the sun gear 28. As a result, this alternating cycle can have a dramatic effect on the HCF (High Cycle Fatigue) life of the spline connection 35. It should be noted that five planet gears 32 are just chosen here as an example. Other embodiments might have more than five planet gears 32 or fewer.

In FIG. 4C the formlocking between the two parts 28, 31 is shown in detail to indicate the contact forces F when e.g. the second part 31 rotates relative to the first part 28.

The spline connection 35 comprises two parts: The internal spline (first part, on the sun gear 28) and the external spline (second part, on the sun shaft 31).

The embodiment described herein comprises spline teeth measurement data for every part to determine a distinct clocking configuration to assemble every pair of sun shaft 31 and sun gear 28 such that alternating contact force is minimized and hence the HCF strength of the parts are maximized.

### Input Data

The teeth of the spline connection, i.e. the two parts 28, 31 are considered as parts having fixed geometries. This means, the geometries as such are not changed during the following procedure. The procedure is about assembling the two parts in an optimal way.

The spline connection 35 in the exemplary embodiment is specified as a Tolerance Class of 5. This is a standard that specifies the tolerance associated with the spline connection. The embodiments described herein can be applied to other tolerance classes. In essence, embodiments are applicable to any spline that is manufactured with a method that produces a distribution of resulting geometries:

between teeth 180° apart: 173 microns for both splines together (or 86.5 microns each spline).
between two adjacent teeth: 43 microns. (which is ¼ of the sum of internal and external accumulative pitch deviations.

Based on the Tolerance Class 5, the internal and external spline set of positional tolerances are calculated or measured, i.e. a deviation from a design value (FIG. 5A, 5B). FIG. 5A shows the positional tolerances on the external splines on the sun shaft 31. FIG. 5B shows the positional tolerances on internal splines on the sun gear 28. As expected, the distribution of the tolerances data over the 84 teeth of the spline connection is random, but they not necessarily follow a normal distribution. They will follow a distribution affected by the method of manufacture.

The cumulative positional tolerances are shown in FIG. 6A, 6B of the external spline (FIG. 6A) and the internal spline (FIG. 6B), as a verification of the adherence to the Tolerance Class. From FIGS. 6A, B it can be seen that no teeth 180° apart have a tolerance of more than 173 microns. From FIG. 6A, 6B it can also be seen that no two adjacent teeth have a tolerance of more than 43 microns.

As mentioned above, this can be applied to any tolerance class.

Based on the external and internal positional tolerances (see FIGS. 5A, 5B), a gap is then calculated for each spline tooth pair with existing, fixed geometries, assuming the external and internal splines are fitted together. The gap is the difference between the positional tolerances shown in FIG. 5A and 5B.

The resulting gap between the two splines can be calculated. The position of each spline contact surface is measured relative to the design (i.e. drawing) specifications. For example, if the spline contact surface was manufactured exactly according to the specification the resulting measurement would be 0 mm.

In the following, a measuring convention is established. Consider the embodiment shown in FIG. 4C and a torque application in a clockwise (CW) rotation as shown. If the contact surface is measured to be in the direction of rotation (CW in this case) compared to the nominal position, then the measured value is positive. If the measured position is in the direction opposite to the rotation (CCW in this case) then it is recorded with a negative value. If row 1 of the table below is considered, the contact surface of the external spline (left surface of 31) is measured to be more CCW than the drawing specification and thus takes a negative value of −0.0098 mm. The position of the contact surface of the internal spline (Right surface of 28) is more CW than the drawing specification and thus takes a positive value of 0.0032 mm. In this case, both contact surfaces are contributing to a gap compared to their nominal position (both contact surfaced moved in opposite directions) and thus a theoretical gap of 0.0130 mm exists for this tooth pair.

Another example with interference between teeth is considered. External tooth 21 was measured to be 0.0115 mm CW from nominal position and internal tooth 21 was measured to be 0.0108 CCW from nominal position. This means that both teeth are positioned closer together from nominal position. This pair of teeth has a theoretical interference of 0.0223 mm.

This gap calculation is performed for all the tooth pairs of the external and internal spline. After gap calculation has been made, a new “adjusted” gap needs to be calculated. The tooth pair with the maximum calculated interference indicates which pair of teeth will come into contact first as torque is applied to create a CW rotation. Imagine the two parts are fitted together, then the shaft 31 transmits a torque and is rotated CW until contact occurs. In this case, the contact will first occur at tooth pair 21. Because tooth pair 21 has an interference of 0.0223 mm compared to the nominal position, this means that all other pairs must be adjusted by the interference of tooth pair 21. Therefore, the external spline (31) needs to be rotated CCW by −0.0223 mm (negative value because CCW). Therefore tooth pair 1 gap becomes −0.0130−0.0223=−0.0353 mm.

These “adjusted” gaps are then used in the FEM to calculate the contact forces.

The “adjusted” gap values change for other clocking positions. For example, if external tooth 1 is matched with internal tooth 2 the resulting gap will be −0.0098−0.0042=−0.0140 mm. Then the new max interference tooth pair needs to be determined and the “adjusted” gaps can be calculated. This shows on how the measurements are used to calculate the gaps that are then fed into the FEM analysis.

| | External | Internal | gap | adj gaps |
|---|---|---|---|---|
| 1 | −0.0098 | 0.0032 | −0.0130 | −0.0353 |
| 2 | −0.0022 | 0.0042 | −0.0064 | −0.0287 |
| 3 | −0.0040 | 0.0027 | −0.0067 | −0.0290 |
| 4 | −0.0110 | 0.0021 | −0.0131 | −0.0354 |
| 5 | 0.0010 | −0.0062 | 0.0072 | −0.0151 |
| 6 | −0.0001 | 0.0083 | −0.0084 | −0.0307 |
| 7 | 0.0049 | −0.0115 | 0.0164 | −0.0059 |
| 8 | 0.0084 | 0.0020 | 0.0064 | −0.0159 |
| 9 | −0.0090 | 0.0109 | −0.0199 | −0.0422 |
| 10 | −0.0114 | −0.0054 | −0.0060 | −0.0283 |
| 11 | 0.0039 | −0.0020 | 0.0059 | −0.0164 |
| 12 | 0.0040 | 0.0010 | 0.0030 | −0.0193 |
| 13 | 0.0049 | 0.0068 | −0.0019 | −0.0242 |
| 14 | −0.0045 | −0.0050 | 0.0005 | −0.0218 |
| 15 | −0.0016 | 0.0038 | −0.0054 | −0.0277 |
| 16 | −0.0067 | 0.0092 | −0.0159 | −0.0382 |
| 17 | 0.0000 | 0.0120 | −0.0120 | −0.0343 |
| 18 | −0.0088 | 0.0056 | −0.0144 | −0.0367 |
| 19 | 0.0050 | 0.0027 | 0.0023 | −0.0200 |
| 20 | −0.0020 | −0.0074 | 0.0054 | −0.0169 |
| 21 | 0.0115 | −0.0108 | 0.0223 | 0.0000 |

Then the minimum resulting gap of all of the tooth pairs is calculated and all the spline pair tooth gaps are offset by this amount.

In effect, the minimum tooth pair gap becomes zero as the first tooth pair comes into contact. The end result is the gap of each tooth pair as shown in FIG. 7A termed clocking #1. The cumulative gap is smallest in this configuration

The internal and external spline can be assembled in many ways as the number of spline teeth (clocking). Another—non-optimal—gap distribution is shown in FIG. 7B, i.e. at clocking #2.

In the following, these gaps are inputs for a FEM analysis that is used to calculate the contact force on each spline pair when torque is applied.

### Analysis

To simplify the analysis, a FEM model was created including the sun gear 28 and a partial sun shaft 31. A moment is then applied at the sun shaft 31, which in turn transfers it via the spline connection 35 to the sun gear 28 and finally the load is reacted at the helical teeth representing the five planet gears 32 (see FIG. 4A). The planet gears 32 are in this particular case not modelled but represented as normal to tooth constraints. The spline connection 35 is modelled with frictional non-linear contact.

### Idealized Spline

The contact forces between the teeth of the spline 35 are calculated when considering an idealised spline (equal load share amongst spine teeth, all gaps=0 mm) as shown in FIG. 8. As the planet gear 32 rotates around the sun shaft 31, the contact force varies from roughly 7.6 kN to 11 kN.

In this idealized calculation the actually measured tolerances of the teeth are not considered.

### Spline Contact Force Including Positional Tolerances

The same FEM program can be used to capture the variation in spline contact force when the positional tolerances as described above are considered.

The gap of each tooth pair 28, 31 having fixed geometries is simulated by offsetting the spline contact surfaces by the specified amount. Using the gap distribution of each clocking position the resulting spline contact force of each tooth pair is then calculated. To capture completely the variation in contact force the following is considered:

84 clocking positions (84 tooth spline)
For each clocking position, for each tooth, two planet gear 32 positions are required to capture the max and min contact force

When the spline tooth is directly below the planet gear 32, that tooth sees the maximum possible contact force (shortest load path).

When the spline tooth is between two planet gears 32, that tooth sees the minimum possible contact force (longest load path).

This yields a total of 84*2=168 analyses to determine which clocking position results in the better distribution of contact force, if the tooth that generates the maximum contact force is known.

FIG. 9 shows the contact force distribution for the clocking position #1 (see FIG. 7A) taking into account the positional tolerances. Clearly, the spline contact force distribution is no longer a smooth pattern as in FIG. 8. The variation in force has significantly increased when taking into account the positional tolerances. The contact forces vary between 0 and 38 kN.

FIG. 10 shows what happens to the contact force distribution when another planet gear 32 position is analyzed.

FIG. 11 shows how the contact force distribution changes when the parts are assembled in clocking position #2 (see FIG. 7B). The contact forces vary between 0 and 36 kN.

FIG. 12 shows what happens to the contact force distribution when another planet position is analyzed for clocking #2.

By comparing the contact force data for the clocking position #1 with that of clocking position #2 it is evident that the maximal contact forces are significantly reduced in the clocking #2 case compared to clocking #1. These clocking positions were randomly selected and are only 2 of 84 possible to illustrate the effect.

### Optimal Clocking Position

As stated, there are as many possible clocking positions as there are spline teeth. Using the FEM, the spline contact force of every tooth pair for every clocking position can be calculated.

FIG. 13 shows the resulting maximum spline contact force of each of the clocking positions. Clearly, there is large variation ranging from 52.7 kN to 35.3 kN for clocking position #14 and #68 respectively.

For clocking position #14 (maximum contact force) and #68 (minimum contact force), FIG. 4 shows in detail what happens to the spline contact force of one tooth as a planet gear 32 passes by.

The optimal clocking position in the case shown is clocking position #68. If the parts are assembled in clocking position #68, this leads to a reduction of the maximum contact force by 33% and contact force range by 27% (FIG. 4) compared against the worst case (see Table 1).

Overloading one tooth can lead to the entire spline failing and should be avoided.

The embodiments of a method presented comprise spline teeth measurement data of every part to determine a distinct clocking configuration to assemble every pair of sun shaft 31 and sun gear 28 such that the alternating contact force is minimized and hence the HCF strength of the parts are maximized.

With an epicyclic gearbox 30 utilising a spline connection between sun shaft 31 and sun gear 28, an interaction exists between the teeth of planet gears 32 meshing with the sun gear 28 and the sun gear 28 to sun shaft spline contact forces. This interaction is especially pronounced in a gearbox 30 of a geared turbofan engine due to its relative thin cross-section. The thin cross-section is necessary to accommodate the fan shaft, as well as to minimize weight. In effect, this interaction inflicts an alternating contact force on each spline tooth as the planet gear 32 passes.

The embodiment comprises obtaining spline teeth measurement data for every part to determine a distinct clocking configuration to assemble every pair of sun shaft and sun gear such that alternating contact force is minimized and hence the HCF strength of the parts are maximized.

With any epicyclic gearbox 30 an interaction exists between the planet teeth meshing with the sun gear 28 and the sun gear 28 to sun shaft spline contact forces. This interaction is especially pronounced in a weight-optimised design (such as the PGB) leading to the sun gear having a relative thin cross-section. In effect, this interaction inflicts an alternating contact force on each spline tooth as the planet passes. The number of alternating cycles equals the number of planet gears. In one embodiment five planet gears 32 are used, thus each spline tooth would go through five alternating cycles per one revolution of the sun gear 28. As a result, this alternating cycle can have a dramatic effect on the HCF life of the spline 35.

It will be understood that the invention is not limited to the embodiments described above and various modifications and improvements can be made without departing from the concepts described herein. Except where mutually exclusive, any of the features may be employed separately or in combination with any other features and the disclosure extends to and includes all combinations and sub-combinations of one or more features described herein.

1. A method for positioning two parts with existing, fixed geometries relative to each other in a formlocking connection, the two parts having a plurality of contact faces o transmit contact forces between the two parts,
a) computing for each possible relative position of the two parts the contact forces between the two parts and
b) determining the relative position of the two parts with the minimal contact force among a plurality of relative positions or all possible relative positions and
c) assembling the two parts relative to each other in the position with the minimal contact force.

2. The method according to claim 1, wherein the minimal contact force is defined as the minimal absolute value of the contact forces at the determined relative positions or the average minimal value of the contact forces at the determined relative positions.

3. The method according to claim 1, wherein the alternating contact force is minimized.

4. The method according to claim 1, wherein at least one geometric property is measured in the area of the contact forces.

5. The method according to claim 4, wherein the at least one geometric property is the positional tolerance between the two parts.

6. The method according to claim 1, wherein the formlocking connection comprises a cylindrical spline connection, in particular with a polygonal connection, square splines, serrated splines, straight side splines, involute shaped splines or tapered tooth splines.

7. The method according to claim 1, wherein the formlocking connection comprises a face spline connection, in particular a radial serration spline or a curvic coupling.

8. The method according to claim 1, wherein the first part is a sun gear and the second part is a sun gear of a planetary gearbox, in particular in a geared turbofan engine in an aircraft.

9. A formlocking device with two parts having a plurality of contact faces to transmit contact forces between the two parts, the two parts positionable by a method of claim 1.

10. A gas turbine engine for an aircraft comprising:
an engine core comprising a turbine, a compressor, and a core shaft connecting the turbine to the compressor;
a fan located upstream of the engine core, the fan comprising a plurality of fan blades; and
a gearbox that receives an input from the core shaft and outputs drive to the fan so as to drive the fan at a lower rotational speed than the core shaft, wherein the gearbox comprises a sun gear and a sun shaft assembled by a method of claim 1.
